(19) United States
(12) Patent Application Publication
(10) Pub. No.: US 2006/0005355 A1
(43) Pub. Date: Jan. 12, 2006

(54) Dura T Gate adjustable hinge 003

(76) Inventors: Thomas Lee Wallis, Livermore, CA (US); Sandra Marie Wallis Arellano, Livermore, CA (US)

Correspondence Address: THOMAS L. WALLIS & SANDRA M. WALLIS, 1826 BROADMOOR STREET, LIVERMORE, CA, 94551, US

(21) Appl. No.: 10/877,895

(22) Filed: Jun. 24, 2004

(51) Int. Cl. E05C 7/04

(52) U.S. Cl. 16/237

(57) ABSTRACT

a metal hinge assembly for adjustably mounting a gate in a corresponding gate frame. The two nuts attached to the treaded rod on the upper portion of the hinge allow for the horizontal distance between the gate and the gate post adjustment The vertical distance is achieved by a chamber in the base of the hinge in which an alien key is received and torqued to change the distance between the gate and the gate post.

### FIELD OF THE INVENTION

The present invention relates to a hinge assembly attached between a metal door (doorjamb or gate post) for commercial use, particularly improving horizontal, vertical adjustment for gate doors.

### BACKGROUND OF THE INVENTION

This invention relates to installation of a structure containing a horizontal, vertical adjustable hinge assembly for securing trash gate doors for commercial use, and more particularly to the installation structure of the hinge assembly that will secure the door to attach the hinge assembly and reinforce the strength of the door.

Large, metal gates have been in use for many years, typically, they include a hinge securing the door to a post which is either wood or metal. The door is generally attached to the hinge, when the door is opened, it opens horizontally. In new construction the gate conditions vary, the gate post is cast in concrete, the hole which is dug is always larger than the post, which stands in the concrete to attach the gate door to. When the concrete dries the position of the post varies. The gate door is stood up against the post, no allowance is given with the standard butt hinge. Another drawback with the standard butt hinge, having only a plate appearance with screw holes allows any tension nor force.

In an attempt to address this draw back a vertical, horizontal hinge assembly has been created. Between the gate and a post the hinge assembly, a force to counteract the weight and balance of the gate that address all the adversity of the conventional butt hinge as well as give robust strength to the gate.

A standard butt hinge does not allow for normal wear and tear, nor allow for shrinking in the heat, nor expansion in the cold. Another drawback of the conventional hinge is that no tension is provided, no exerted force can be allowed, attachment provides plate with holes on each plate(right and left) allowing to receive a tool to screw in the holes to the gate post. When it opens it drags. Additionally, no lubrication is provided, rusting is inevitable, the metal wears out. Conventional hinges are designed with a predetermined weight. Non-adjustable hinge may counterbalance a gate by one manufacturer and fail to counterbalance a comparably sized gate door made by another.

The metal hinge assembly exceeds standard hinges with pre determined weight. having approached with non adjustable or coarsely adjustable hinge may counter balance a gate by one manufacture and fail to counterbalance a comparably sized gate door made by another mfg.

To one degree or another a force to counteract the weight of the gate as it opens and closes, resulting in robustly gate construction and non adjustable hinge to the door, no allowance for adjustment either horizontally, vertically. Therefore, the top dimension is not equal to the bottom condition. The general operation was to add shims to the spacing in an effort to level the gate door.

A solution to the above is to provide this hinge assembly with vertical and horizontal ability. Saving unnecessary labor and providing a quality product to the consumer

### SUMMARY OF THE INVENTION

It is an object of the present invention to solve the aforementioned problems and provide an installation structure of a hinge assembly that attaches between a (gate or post) for use with a metal gate door to provide an adjustable connection.

In order to accomplish the aforementioned object of the present invention, there is provided a horizontal and vertical assembly hinge comprising:
a connecting cylindrical housing of cold rolled steel for vertical adjustment
a attached supporting arm including attached rod for horizontal adjustment
a attached housing to include chamber for alien screw, grease fitting
a ball bearing chamber

### BRIEF DESCRIPTION OF THE DRAWINGS

FIG. 1: a perspective view of an invention-related adjustable hinge in the unassembled state.

FIG. 2: a front view of the invention-related adjustable hinge, according to FIG. 1;

FIG. 3: a aerial view of he hinge assembly dis-assembled for horizontal adjustment

FIG. 4: a dis-assembed plan view of the hinge set screw and grease fitting

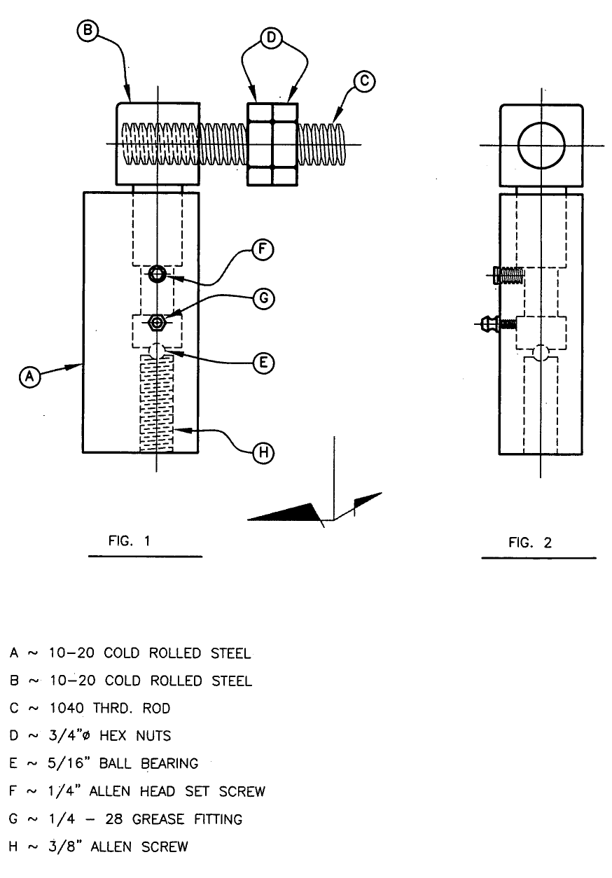

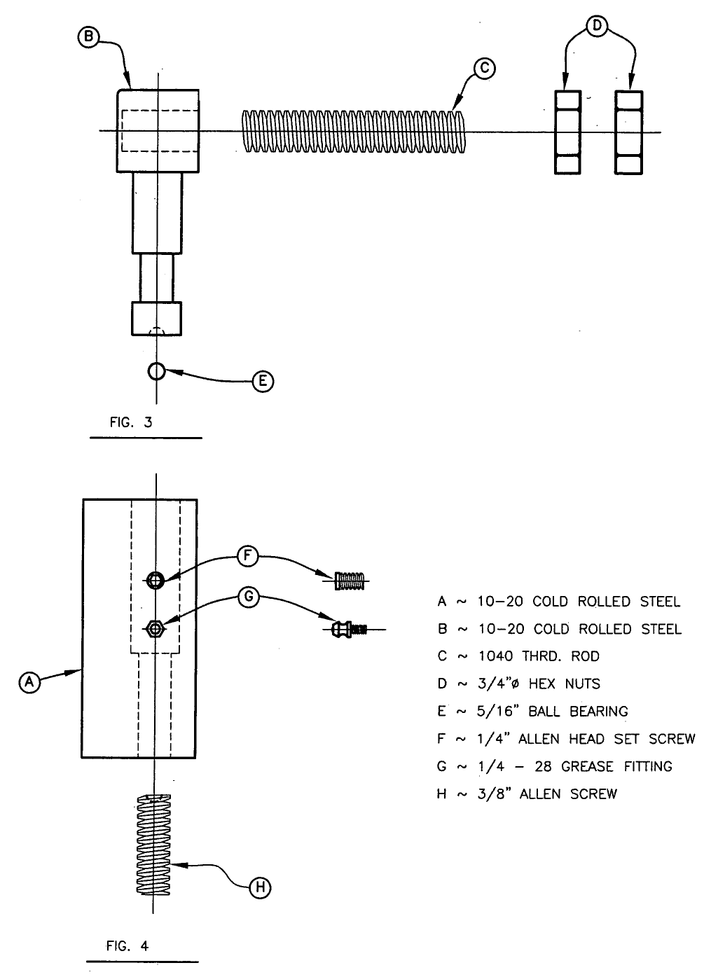

FIG. A: a external side view of the housing illustrating the internal components of the hinge

FIG. B: a view of the rotating support arm that allows vertical adjustment

FIG. C: a external view supports the gate door with threaded rod

FIG. D. a illustration of the nuts on the threaded rod that are removable to place behind the door and in front of the door.

FIG. E. a view of the position of the ball bearing

FIG. F. a illustration of the set screw positioned for stabilizing the gate.

FIG. G. a view of the grease fitting for lubrication

FIG. H. a view locking mechanism locking the bottom hinge to the top

### SPECIFICATION

The Dura T Gate adjustable hinge features a vertical and horizontal adjustment. There are three main parts. The foundation of the hinge is a cold roll 1020 steel, 1½×1¾ wide ×4″ long. The top portion is made from a 1¼×1½×3⅝ solid cold roll steel. The bottom part of the hinge is counter sunk to allow a seat for the 5/16 ball bearing. ½″ from the bottom of the hinge is a ⅛″ groove, ⅝″ long for the locking set screw to allow vertical adjustment and lock the bottom portion of the hinge to the top of the hinge.

Contractors commonly contract with owners of projects for metal gates. In the construction process the two gate posts are cast in concrete first. An opening is made for the concrete to be poured into. The gate post are generally made with 4×4 square tube and they are inserted into that opening, the tube is generally always smaller than that opening. The opening for the concrete post has been dug too deeply, when the concrete dries the gate post is out of alignment. This results in the top dimension not being equal to the bottom dimension for the metal gates to be mounted in a straight manner.

Metal gates do get out of adjustment due to the elements and standard wear and tear. Metal shrinks in the summer and expands in the winter.

What is claimed is:

1. An apparatus for attaching a metal gate to a gate post, comprising:
a hinge assembly with the support elements of metal, such as iron or steel that is adapted to be secured to an exisiting gate post.

2. An adjustable hinge as defined in claim 1, wherein two nuts receive treaded rod that is secured through both sides of the gate post, whereby the distance between the gate post and gate will receive adjusted for horizontal adjustment.

3. An adjustable hinge as defined in claim 2, the vertical distance between the gate and the gate post are achieved through a chamber at the base of the unit which receives an allen key to be torqued.

4. A adjustable hinge as defined in claim 3, the method of adjusting the distance between a metal gate and gate post can be varied without any additional materials.
